(19) United States
(12) Patent Application Publication
(10) Pub. No.: US 2012/0240357 A1
(43) Pub. Date: Sep. 27, 2012

(54) Specially configured elastice band for securing an aerosol spray can extension tube to a spray can for secure storage

(76) Inventor: John R. Nasiatka, Northbrook, IL (US)

(21) Appl. No.: 13/065,327

(22) Filed: Mar. 21, 2011

(51) Int. Cl. B65D 63/10; G09F 3/00

(52) U.S. Cl. 24/16 R; 40/299.01

(57) ABSTRACT

An elastic band specially configured where the two (2) ends are joined together to form an aperture for inserting and securing a plastic extension tube to an aerosol spray can.

### FIELD OF THE INVENTION

This invention relates to an inexpensive device to facilitate the storage of a plastic extension tube commonly used with aerosol spray cans by securing it to the spray can.

### BACKGROUND OF THE INVENTION

Aerosol spray cans are commonly used for dispensing a large number of materials such as lubricants, paints and solvents. The material is typically released from the container by manually operating a spray nozzle. Most spray nozzles are designed to dispense a diffused spray. For those applications requiring a local stream a plastic extension tube in inserted into a recess provided in the spray nozzle and delivers a spot spray when operating the spray nozzle. The extension tube being easy to insert and remove the spray pattern can be easily changed to accommodate the user's requirements.

However, a serious problem associated with the plastic extension tube is it very often becomes separated from the aerosol spray can and gets lost. Once it is lost, the versatility of being able to configure the spray pattern to the user's requirements is no longer possible.

While prior art has offered devices for securing the extension tube to the aerosol can, they have had inherent problems with being expensive, not reusable, difficult to use and not readily adaptable for use by the manufacturers of aerosol spray cans.

Accordingly, it is the object of the present invention to provide an improved, easy to use, inexpensive to manufacture storage device for aerosol spray can extension tubes. It is another object of the present invention to provide a storage means that is sufficiently durable to be used on more than one aerosol spray can. It is still further an object of the present invention to allow the storage device to be placed inside the protective cap positioned on the top of the aerosol spray can by the original manufacturers of the aerosol spray can. Still further, it is an object of the invention to allow for display advertising to be visible on the storage device.

### SUMMARY OF THE INVENTION

The present invention is an improved device for securing an aerosol spray can extension tube to an aerosol spray can. Broadly stated, the device consists of an elastic band which in its free state is smaller in diameter than the aerosol can so as to provide a tight fit when positioned on an aerosol can.

Specifically, the elastic band is specially configured where the two (2) ends are joined together so an aperture is formed between the aerosol can and the elastic band when the elastic band is positioned on the aerosol can. This allows the plastic extension tube to be inserted into the formed aperture and then be moved over and under the elastic band for secure storage.

The advantages of the present invention will be readily understood with reference to the following specifications and attached drawings wherein:

### BRIEF DESCRIPTION OF THE DRAWINGS

FIG. 1 is a perspective view of an aerosol spray can with the spray nozzle. An elastic band is centrally positioned on the aerosol can with the extension tube secured under the elastic band. An extension tube appears above and on the side of the aerosol can with a phantom line showing how it would be placed into the aperture formed between the elastic band and the aerosol can.

FIG. 2A is a top view of the elastic band showing the special configuration developed where the two (2) ends are joined together.

FIG. 2B is a front view of the elastic band.

FIG. 2C is a side view of the elastic band showing display advertising placed on the band.

FIG. 3 is a cross section view showing the elastic band around the aerosol can with the aperture that is formed between the aerosol can and the elastic band.

### DETAILED DESCRIPTION OF THE DRAWINGS

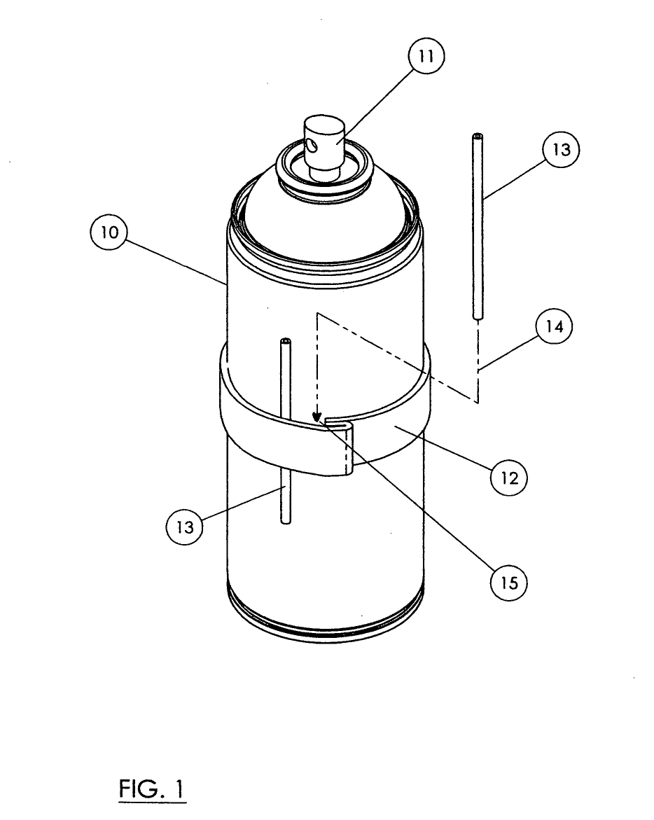

FIG. 1 is a perspective view of an aerosol spray can 10 with a spray nozzle 11. An elastic band 12 centrally positioned on the aerosol can 10 with an extension tube 13 secured under the elastic band 12. A phantom line 14 indicates how a typical extension tube 13 would be placed into the aperture 15 formed between the aerosol spray can and the elastic band before moving the extension tube 13 over to its secured storage position.

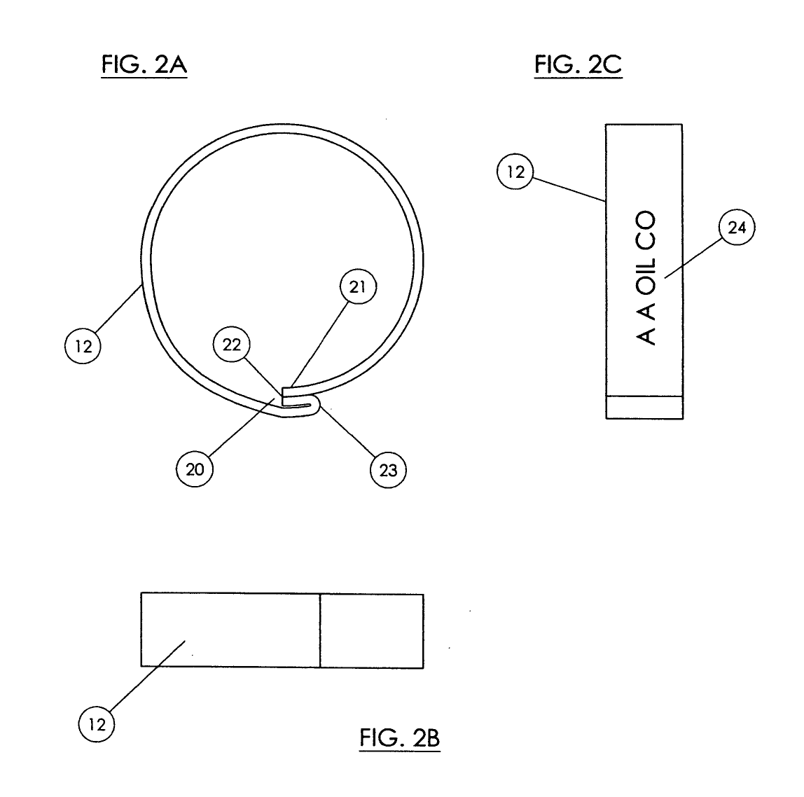

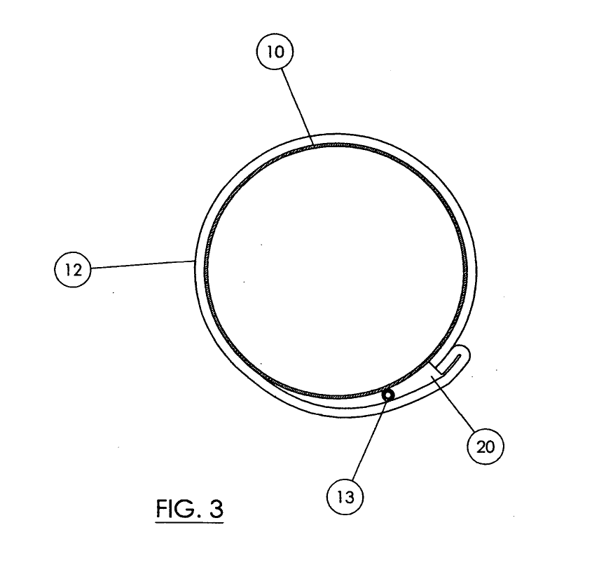

FIG. 2A is a top view of the elastic band 12 with the special configuration developed where the one end of the elastic band 21 is joined together with the opposite end of the elastic band 22 with the folded over segment 23 thereby forming aperture 20 when positioned on a spray can.

2B is a front view of the elastic band 12.

2C is a side view of elastic band 12 showing display advertising 24 as it would appear when place on the elastic band 12.

is a cross section view through the aerosol spray can 10 and the elastic band 12 showing the aperture 20 that is formed between the aerosol can 10 and the elastic band 12 from the special configuration of the elastic band 12 where the two (2) ends of the elastic ban 12 is joined together.

Obviously, many modifications and variations of the present invention are possible in light of the above teachings. Therefore, it is to be understood that within the scope of the appended claims the invention may be appreciated otherwise than as specifically described above.

What is claimed and desired to be secured by a Letters Patent of the United States is:

1. A device for securing an aerosol spray can extension tube to a spray can comprising:
a wide elastic band configured at the joined ends so as to form an aperture between the elastic band and the spray can when positioned on the aerosol spray can; and
said aperture allowing for easy insertion of an aerosol spray can extension tube between the elastic band and the spray can; and
elastic band being smaller in diameter than the diameter of the aerosol spray can to provide a tight fit when the elastic band is positioned on the aerosol spray can.

2. The device as recited in claim 1 wherein said device can be imprinted with display information and/or display advertising.
